(19) United States
(12) Patent Application Publication
(10) Pub. No.: US 2005/0273817 A1
(43) Pub. Date: Dec. 8, 2005

(54) Delivering consumer service information to a user via the user's television service carriers

(75) Inventors: Herman Rodriguez, Austin, TX (US); Newton James Smith JR., Austin, TX (US); Clifford Jay Spinac, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 10/860,411

(22) Filed: Jun. 3, 2004

(51) Int. Cl. H04N 5/445; G06F 3/00; H04N 7/10; H04N 7/025; H04N 7/173

(52) U.S. Cl. 725/46; 725/31; 725/34

(57) ABSTRACT

A method, system, and program for delivering consumer service information to a user via a user's television service carrier are provided. A user places a call to a consumer service center and selects to receive information displayed at the user's television. An identification for a user's television service carrier and the user's account number are retrieved by the consumer service center. The consumer service center contracts with the user's television service carrier for bandwidth for information delivery. Then, the consumer service center delivers the information via the user's television service carrier in association with the user's account number, such that the user receives the information at a television interface receiving the information over the contracted bandwidth from the user's television service carrier.

### BACKGROUND OF THE INVENTION

1. Technical Field

The present invention relates in general to improved consumer service and in particular to a method for delivering consumer service information. Still more particularly, the present invention relates to a consumer provider delivering information to a user at a television interface via the user's television service carrier.

2. Description of the Related Art

Previously, when a consumer purchased a product or service, it was typical for the consumer to receive a printed service guide for the product or service information that provided information about setup, operation, configuration, service, or maintenance of the product or service. Recently, however, printed service guides and other guides are more frequently left out due to the cost of printing, the cost added to shipping from the weight of the service guide, and the packaging space required for the service guide. In addition, recently, rather than printing a service guide, a manufacturer or other distributor may provide a consumer with web page addresses indicating the locations of service guide materials available via the Internet. The Internet provides an additional advantage in that the information can be searched more quickly and customized and updated for the product or service purchased by a consumer.

Expecting consumers to access service guides through the Internet only, however, is a limited solution to reducing the costs and space associated with service guides and other information that could be provided in a printed format. In particular, while the number of users of the Internet is growing, overall there are still only a limited number of consumers with access to the Internet and even if a consumer does have access to the Internet that consumer may not have sufficient bandwidth to access detailed information. Further, even if a consumer has a computer with access to the Internet, consumers often experience problems accessing the Internet from computers. Thus, for those consumers currently without effective Internet access who need product or service information, the consumer's only option for service information is to call customer service and receive the information via the telephone call. Further, unless the web page interface for a service guide is consumer friendly, consumers may give up on trying to find information through the Internet and call customer service. While customer service numbers have been in use for many years as a way to provide consumers with customized information, customer service calls are constrained by the limited amount of information that can be effectively communicated by a service representative or by pre-recorded messages.

In view of the foregoing, there is a need for a highly consumer available method, system and program for delivering product and service information in a medium that is highly available to consumers and readily deliverable and customizable on demand by the provider of the product or service.

### SUMMARY OF THE INVENTION

In view of the foregoing, the present invention provides improved customer service and in particular provides a method, system, and program for a consumer service center that delivers consumer service information to a user via the user's television service carrier.

According to one aspect of the invention, an identification for a user's television service carrier and the user's account number are retrieved for a user seeking information from a consumer service center. The consumer service center contracts the user's television service carrier for bandwidth for information delivery. Then, the consumer service center delivers the information via the user's television service carrier in association with the user's account number, such that the user receives the information at a television interface receiving the information over the contracted bandwidth from the user's television service carrier.

According to another aspect of the invention, a user contacts a call center provided by the consumer service center. The user is prompted to select to receive information from the consumer service center via the user's television service carrier. If the user selects to receive information from the consumer service center via the user's television service carrier, then the user is prompted to provide an identifier for the user's television service carrier and the user's account number. Alternatively, the user's television service carrier and user's account number may be determined from the user's identity or other information. The user may be prompted to select to receive information via the user's television service carrier and prompted to provide identification from an interactive voice response unit or by a service representative. The user may still be on the line with a service representative when the information is delivered to the user's television interface or the information may be scheduled for delivery at a time after the user's communication with the call center terminates.

The information provided to a user may be personalized according to the type of information need by the user. In addition, the information delivery to the user may be customized according to user inputs, such as a language preference and a level of depth or knowledge of the user. The consumer service center may charge the user for delivery of some types of information.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of an information delivery system utilizing existing television service carriers to deliver information from consumer service centers to consumers in which the present invention may be implemented;

FIG. 2 depicts one embodiment of a computer system which may be implemented in the present invention;

FIG. 3 depicts one embodiment of an information delivery system delivering information to a particular user via the user's television carrier;

FIG. 4 depicts a block diagram of one embodiment of components of a call center in accordance with the method, system, and program of the present invention;

FIG. 5 depicts a block diagram of one embodiment of information included in an information database in accordance with the method, system, and program of the present invention; and

FIG. 6 depicts a high level logic flowchart of a process and program for controlling an information delivery system for distribution information to users via a television in accordance with the method, system, and program of the present invention.

### DETAILED DESCRIPTION OF THE PREFERRED EMBODIMENT

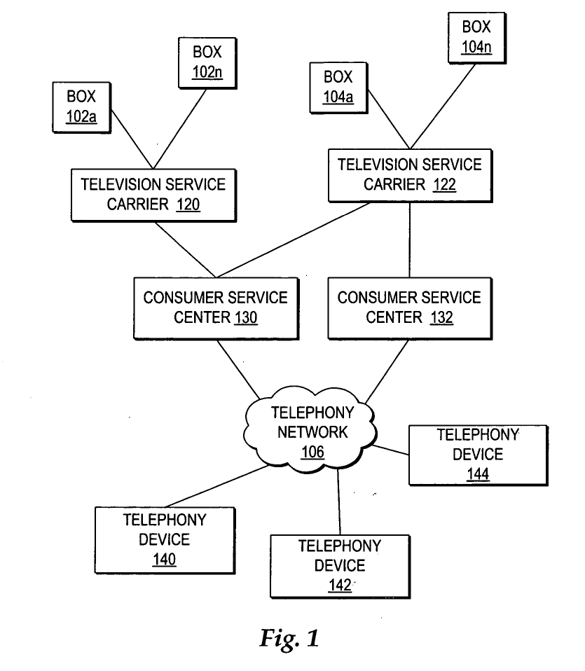

With reference now to the drawings, and in particular to FIG. 1, there is depicted one embodiment of an information delivery system utilizing existing television service carriers to deliver information from consumer service centers to consumers in which the present invention may be implemented. In the example, consumers using telephony devices 140, 142, and 144 may place or receive calls via a telephony network 106 to any of consumer service centers 130 and 132. Telephony network 106 may include both wired and wireless telephone networks implemented within an Internet based telephony network, public switching telephone networks (PSTN), integrated services digital networks (ISDN) and other telephony supportive networks.

Each of consumer service centers 130 and 132 may include call centers established by product and service providers to receive consumer calls. For example, when a manufacturer or distributor provides a product or service, the printed information provided with the product or service may include a toll-free consumer service number that a consumer may call to access the call center and receive further information about the product or service. Thus, each of consumer service centers 130 and 132 facilitate providing consumers with information related to a specific product or service, where the information includes, but is not limited to, setup information, operational information, maintenance information, configuration information, and service information. In addition, other types of information about events and opportunities may be provided by consumer service centers 130 and 132. It is important to note that while the present embodiment is described with reference to “consumers” receiving information from a “consumer service center” the recipients of information may include consumers, business customers, and the general public, for example.

According to an advantage of the invention, consumer service centers 130 and 132 may deliver product and service information to a consumer at a television interface accessible to the consumer, in addition to the standard customer support services provided to the consumer via telephone by the call center. For example, consumers accessing one of consumer service centers 130 and 132 via a telephony device may be connected with a service representative, placed on hold, or prompted to select from options, including the delivery of information at a television accessible to the consumer, by an interactive voice response unit. If the consumer selects to have information delivered to a television interface, then a television service carrier and account number are accessed for the consumer, and consumer service centers 130 and 132 enable delivery of information to a consumer through the television service carrier to which the consumer subscribes. It is important to note that while the present invention describes a television service carrier and account number as associated with the consumer or user placing the call, it will be understood that a television service carrier and account number selected by a consumer may include associations with a business, organization, household, or other group. Furthermore, it is important to note that one consumer may place the call and request information for viewing by another consumer or a group of consumers.

In the example, consumer service center 130 delivers information to consumers through television service carriers 120 and 122 via a network connection. Television service carriers 120 and 122 support delivery of the information content to boxes 102a-102n and boxes 104a-104n, where each box is associated with a particular user account. Output interfaces that receive the signal from boxes 102a-102n and 104a-104n control output of the delivered content to the consumer. Television service carriers 120 and 122 may include both cable and satellite service providers, for example. In addition, it will be understood that television service carriers 120 and 122 may provide consumers with access to multiple types of media including, but not limited to, Internet access, television access, and gaming access. It is important to note that either consumer service center 130 or one of television service carriers 120 and 122 may be designated to control the delivery of information to consumers through television service carriers 120 and 122.

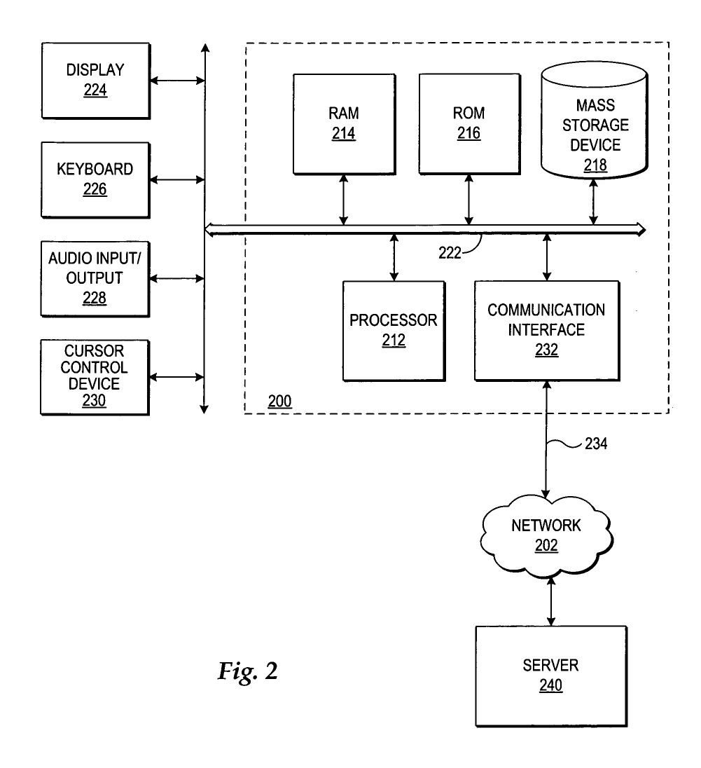

Referring now to FIG. 2, there is depicted one embodiment of a computer system which may be implemented in the present invention. The present invention may be executed in a variety of systems, including a variety of computing systems under a number of different operating systems. In general, the present invention is executed in a computer system that performs computing tasks such as manipulating data in storage that is accessible to the computer system. In addition, the computer system includes at least one output device and at least one input device. Further, the computer system may be further classified as an electronic device, a scanner, a server, or other system, configured to perform particular processes and functions.

In general, computer system 200 includes a bus 222 or other communication device for communicating information within computer system 200, and at least one processing device such as processor 212, coupled to bus 222 for processing information. Bus 222 preferably includes low-latency and higher latency paths that are connected by bridges and adapters and controlled within computer system 200 by multiple bus controllers. When implemented as a server system, computer system 200 typically includes multiple processors designed to improve network servicing power.

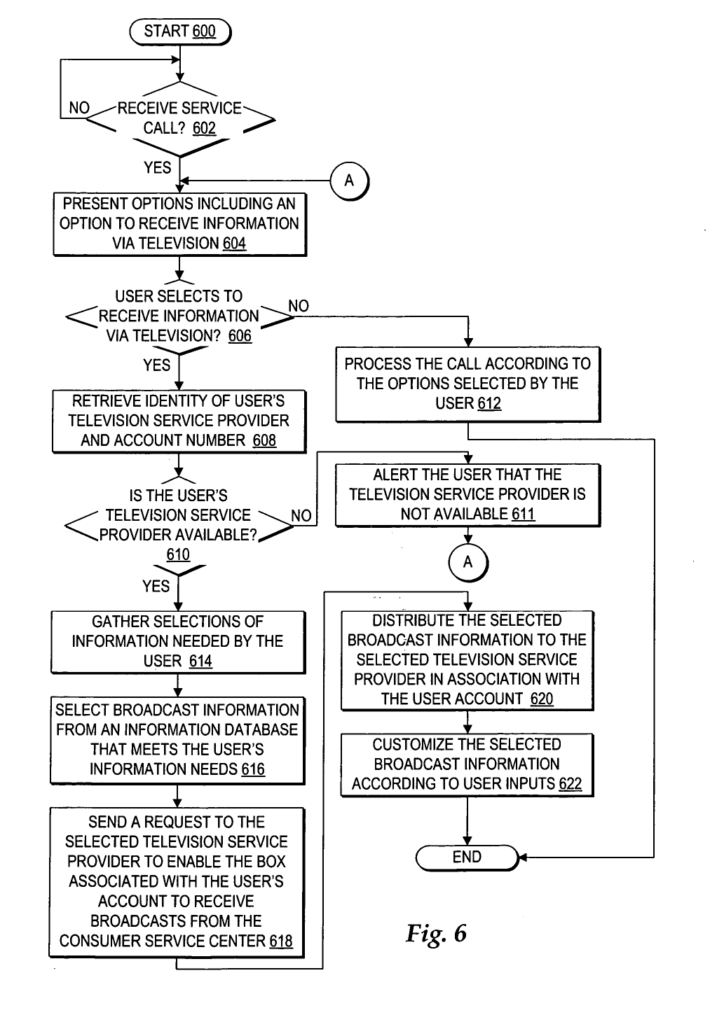

Processor 212 may be a general-purpose processor such as IBM's PowerPC™ processor that, during normal operation, processes data under the control of operating system and application software accessible from a dynamic storage device such as random access memory (RAM) 214 and a static storage device such as Read Only Memory (ROM) 216. The operating system preferably provides a graphical user interface (GUI) to the user. In a preferred embodiment, application software contains machine executable instructions that when executed on processor 212 carry out the operations depicted in the flowcharts of FIG. 6, and other operations described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium (or computer operable medium) having stored thereon the machine executable instructions (or program code) used to program computer system 200 to perform a process according to the present invention. The terms “machine-readable medium” and “computer operable medium” as used herein, include any medium that participates in providing instructions to processor 212 or other components of computer system 200 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 200 can read and which is suitable for storing instructions. In the present embodiment, an example of a non-volatile medium is mass storage device 218 which as depicted is an internal component of computer system 200, but may be understood to also be provided by an external device. Volatile media include dynamic memory such as RAM 214. Transmission media include coaxial cables, copper wire or fiber optics, including the wires that comprise bus 222. Transmission media can also take the form of acoustic, electromagnetic, or light waves, such as those generated during radio frequency or infrared data communications.

Moreover, the present invention may be downloaded as a computer program product, wherein the program instructions may be transferred from a remote computer such as a server 240 to requesting computer system 200 by way of data signals embodied in a carrier wave or other propagation medium via a network link 234 (e.g. a modem or network connection) to a communications interface 232 coupled to bus 222. Communications interface 232 provides a two-way data communications coupling to network link 234 that may be connected, for example, to a local area network (LAN), wide area network (WAN), an Internet Service Provider (ISP), or a television network. In particular, network link 234 may provide wired and/or wireless network communications to one or more networks.

Network link 234 provides data communication services through network 202. Network 202 may refer to the worldwide collection of networks and gateways that use a particular protocol, such as Transmission Control Protocol (TCP) and Internet Protocol (IP), to communicate with one another. Network link 234 and network 202 both use electrical, electromagnetic, or optical signals that carry digital data streams. The signals through the various networks and the signals on network link 234 and through communication interface 232, which carry the digital data to and from computer system 200, are exemplary forms of carrier waves transporting the information.

When implemented as a server system, computer system 200 typically includes multiple communication interfaces accessible via multiple peripheral component interconnect (PCI) bus bridges connected to an input/output controller. In this manner, computer system 200 allows connections to multiple computers via network 202.

When implemented as a portable electronic device, computer system 200 typically also includes a battery for providing power to the components of computer system 200. Further, when implemented as a portable electronic device, computer system 200 may not include all the components illustrated due to the compact nature of many electronic devices.

Further, multiple peripheral components may be added to computer system 200, connected to multiple controllers, adapters, and expansion slots coupled to one of the multiple levels of bus 222. For example, an audio input/output (I/O) device 228 is connectively enabled on bus 222 for controlling audio input through a microphone or other sound or lip motion capturing device and for controlling audio output through a speaker, a headset, or other audio projection devices. A display 224 is also connectively enabled on bus 222 for providing visual, tactile or other graphical representation formats. A keyboard 226 and a cursor control device 230, such as a mouse, trackball, or cursor direction keys, are connectively enabled on bus 222 as interfaces for user inputs to computer system 200. In alternate embodiments of the present invention, additional input and output peripheral components may be added.

Those of ordinary skill in the art will appreciate that the hardware depicted in FIG. 2 may vary. Furthermore, those of ordinary skill in the art will appreciate that the depicted example is not meant to imply architectural limitations with respect to the present invention.

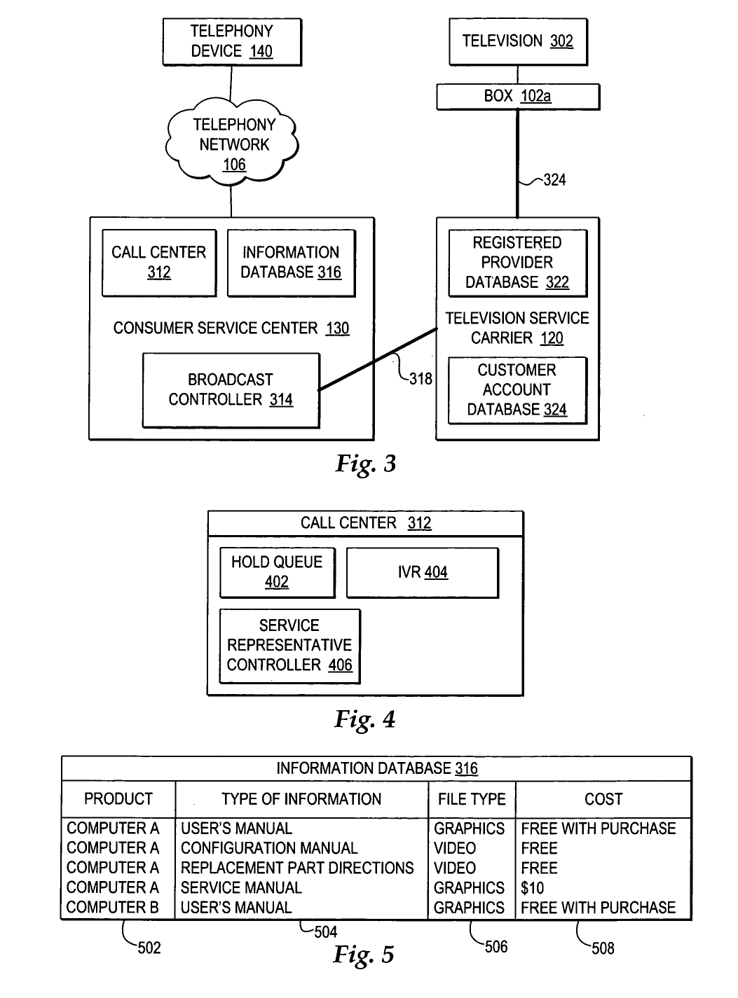

With reference now to FIG. 3, there is illustrated one embodiment of an information delivery system delivering information to a user via the user's television service carrier. As depicted, television service carrier 120 provides service for a user account associated with box 102a via a communication channel 324. Box 102a then controls the display of the signal received from television service carrier 120 on a television 302. Communication channel 324 may include, but is not limited to, a satellite communication channel and a cable communication channel. Television 302 may include, but is not limited to, a standard television, a high density television, a computer system, and other display interfaces. In addition, box 102a may provide a signal to multiple television devices.

In the example depicted, different consumer service centers contract with television service carrier 120 for bandwidth and channels across the distribution spectrum. In particular, a particular product or service provider that implements consumer service center 130 has contracted with television service carrier 120 for bandwidth and channels for distribution of information to consumers who subscribe to television service carrier 120. The distribution spectrum may include, for example, local channels, regional channels, national channels, and worldwide channels. The bandwidth and channel specifications for each consumer service center are included in a registered provider database 322.

In addition, in the example depicted, the particular product or service provider implements consumer service center 130 to facilitate reception of user requests, and distribution and customization of product and service information. In particular, consumer service center 130 includes a call center system 312. Call center system 312 answers telephone calls from users and may place telephone calls to users. In the example, a user places a call via telephony network 106, using telephony device 140, to a customer service number, where calls to the customer service number are answered by call center system 312. When call center system 312 answers the call, the user may be directly connected to a service representative, placed in a hold queue, or directed to select from options by an interactive voice response (IVR) unit.

When the user is connected to or directed to an interactive voice response (IVR) unit within call center system 312, the user is prompted to select from multiple menu options. Among the menu options, the user may select to receive information related to a particular product or service displayed at the user's television. If the user selects to receive information related to a particular product or service at the user's television, the user is then prompted within call center 312 to provide a television service carrier identifier and an account number. Broadcast controller 314 determines whether consumer service center 130 contracts with the television service carrier identified by the user. If consumer service center 130 does not contract with the television service carrier identified by the user, then consumer service center 130 may attempt to contract with the television service carrier or may place the user's call in a queue awaiting answer by a service representative. If consumer service center 130 contracts with the television service carrier identified by the user, then broadcast controller 314 automatically selects information related to the user request from an information database 316 and opens a communication channel 318 to television service carrier 120 for distribution of the selected information to television service carrier 120. Television service carrier 120 verifies the user's account number in customer account database 324 and returns a verification to broadcast controller 314. Next, broadcast controller 314 schedules and distributes the selected information as a broadcast through television service carrier 120 to box 102a. In particular, a service code is passed from television service carrier 120 to box 102a so that box 102a is enabled to receive information via the channel assigned for the selected information broadcast.

In another embodiment, the user is placed on hold within call center 312 and then the call is answered by a service representative. The service representative converses with the user and selects the type of information from information database 316 that will answer the user's question or fulfill the user's request. In addition, the service representative acquires and enters the user's television service carrier and account number information for use by broadcast controller 314. Broadcast controller 314 enables and schedules delivery of the selected information to be broadcast through the user's television service carrier 120 to box 102a associated with the user's account.

In one example, rather than requiring a user to enter or provide a television service carrier identity and account information to a service representative, the television service carrier identity and account information may be determined from the user's identity. Alternatively, the user may indicate a location of a box (e.g. a street address), wherein the consumer service center accesses a database to determine the television service carrier and account providing service to the box location.

In addition to selecting and customizing information from information database 316 for broadcast to a particular user, broadcast controller 314 may further customize the selected broadcast information. For example, broadcast controller 314 may adjust a language for the selected broadcast information. In addition, for example, broadcast controller 314 may the content for the level or depth of knowledge of the recipient. For example, within a user's manual, a novice would need the most basic content such as how to turn on a computer, but a more experienced user may not need this basic content. In addition, for example, broadcast controller 314 may support rerunning, pausing, and rewinding the selected broadcast information as requested by the user.

Broadcast controller 314 may control delivery of the selected broadcast information to the consumer via box 102a at television 302 while the user is still engaged in a telephone call with call center 312. Alternatively, in another example, broadcast controller 120 schedules delivery of the selected broadcast information to the user via box 102a at a later time when the selected broadcast information is fully compiled or when the user or a group of users are available to receive the broadcast at television 302 or multiple televisions receiving the broadcast signal. Where a broadcast is scheduled for multiple users, the multiple users may be informed of the broadcast schedule via a communication channel such as electronic mail (e-mail), instant messaging, a message board, a telephone call or a television channel designated for communicating scheduled broadcasts of consumer service information from independent consumer service centers. Moreover, when multiple users are to receive a community broadcast of selected consumer service information, each user or a selection of users may select a time for the community broadcast via the communication channel from among pre-designated time slots, suggested time slots, or user specified time slots.

A consumer service center or other information provider may provide selected broadcast information at no cost or may charge a user a fee for delivery of portions or all of the selected broadcast information. For example, more detailed information may be provided to user, but only for a fee. The fee may be metered by television service carrier 120 or by broadcast controller 314.

A user may select to record selected broadcast information for future reference. In particular, box 120a may enable recordings of selected broadcast information or an external recording system enabled to receive the selected broadcast information from box 102a may enable recordings of the selected broadcast information.

Referring now to FIG. 4, there is depicted a block diagram of one embodiment of components of a call center in accordance with the method, system, and program of the present invention. As depicted, a call center 312 includes multiple components. In particular, call center 312 includes a hold queue 402 that provides a storage system for answering and holding calls.

While a call is held in hold queue 402, the caller may be presented with a selectable menu of options, as presented by an IVR 404. The selectable menu of options may request the caller to select a type of product or service, a type of problem, a type of representative to talk with, a type of pre-recorded message to listen to, or a type of information to receive via television. If a caller selects to receive a type of information via television, the caller may be further prompted with options that will narrow the information to be selected for broadcast to the caller via television. In addition, if a caller selects to receive a type of information via television the caller may be prompted to provide an identifier for a television service carrier and an account number for the subscription with the television service carrier.

A call may also be transferred from hold queue 402 to a service representative as controlled by service representative controller 406. Although not depicted, multiple service representative lines are controlled by service representative controller 406. In addition, service representative controller 406 may control an interface provided to service representatives, where the interface instructs service representatives, provides information about the consumer, provides a selectable directory of the data in information database 316, and provides an interface for the service representative to request and schedule that selected information be broadcast to the caller at a television via a caller's television service carrier.

With reference now to FIG. 5, there is depicted a block diagram of one embodiment of information included in an information database in accordance with the method, system, and program of the present invention. As depicted, information database 316 includes multiple types of catalogued information ready for broadcast to a user at a television. In the example, each of the catalogued information files is described in columns indicating a product 502, a type of information 504, a file type 506, and a cost 508. It will be understood that additional columns may be added with additional entries to describe each of the catalogued information files.

In the example depicted, five catalogued information files are described for purposes of illustration. The product type is described, such as “computer A” and “computer B”. In addition, the type of information is described, such as “user's manual”, “configuration manual”, “replacement part directions”, and “service manual”. Further, the type of file format is described, such as “graphics” and “video”. Finally, a cost associated with each file is described where information is either free or available for a fee. In the example, a “user's manual” is available with purchase, but a more detailed “service manual” is available for a fee. It will be understood that in addition to products, information files for services may also be included in information database 316. Further, it will be understood that files for products and services of multiple consumer providers may be included in information database 316. Moreover, it will be understood that multiple types of information files may be included in information database 316 and that the information files may include audio files, graphics files, text files, video files, and multi-media files, ready for broadcast to a consumer via the consumer's television service carrier.

Referring now to FIG. 6, there is depicted a high level logic flowchart of a process and program for controlling an information delivery system for distribution of information to users via a television in accordance with the method, system, and program of the present invention. As depicted, the process starts at block 600 and thereafter proceeds to block 602. Block 602 depicts a determination whether a service call is received. Once a service call is received, then the process passes to block 604.

Block 604 depicts presenting the user placing the call with options, including an option to receive information via television. Next, block 606 depicts a determination whether the user selects to receive information via television. If the user does not select to receive information via television, then the process passes to block 612. Block 612 depicts processing the call according to the options selected by the user, and the process ends. Otherwise, at block 606, if the user does select to receive information via television, then the process passes to block 608. Block 608 depicts retrieving the identity of the user's television service carrier and an account number and the process passes to block 610. It will be understood that a user may respond to an automated menu to select to receive information and may provide input via the telephone input interface identifying the television service carrier and account number. Alternatively, the user may respond to a service representative query to select to receive information via television and may tell the service representative the television service carrier and account number, which are then entered by the service representative.

Block 610 depicts a determination whether the user's television service carrier is available to the consumer service center for broadcasting information to the user. If the user's television service carrier is not available, then the process passes to block 611. Block 611 depicts alerting the user that the television service carrier is not available and the process returns to block 604. Otherwise, at block 610, if the user's television service carrier is available, then the process passes to block 614.

Block 614 depicts gathering selections of information needed by the user. In particular, the user may be prompted by an IVR or by a service representative to narrow down the type of information needed. Next, block 616 depicts selecting broadcast information from an information database to meet the user's information needs. Next, block 618 depicts sending a request to the selected television service carrier to enable the box associated with the user account to receive broadcasts from the consumer service center. Thereafter, block 620 depicts distributing the selected broadcast information to the selected television service carrier in association with the user account number. Then, block 622 depicts customizing the selected broadcast information according to user inputs, and the process ends.

While the invention has been particularly shown and described with reference to a preferred embodiment, it will be understood by those skilled in the art that various changes in form and detail may be made therein without departing from the spirit and scope of the invention.

1. A method for delivering information to a user via a television service carrier, comprising:
retrieving a television service carrier identification and account number for a user seeking information from a consumer service center, wherein said consumer service center contracts with said identified television service carrier for bandwidth for information delivery; and
delivering said information via said identified television service carrier in association with said account number, such that said user is able to receive said information at a television interface receiving said information over said contracted bandwidth from said identified television service carrier.

2. The method for delivering information to a user according to claim 1, further comprising:
receiving a call from said user at a call center provided by said consumer service center;
prompting said user to select to receive said information from said consumer service center via a television;
responsive to said user selecting to receive said information from said consumer service center via said television, retrieving said television service carrier identification for said identified television service carrier and said account number for said user.

3. The method for delivering information to a user according to claim 2, further comprising:
prompting said user by a service representative to select to receive said information from said consumer service center via said television; and
prompting said service representative to retrieve said television service carrier identification for said identified television service carrier and said account number from said user.

4. The method for delivering information to a user according to claim 1, further comprising:
charging said user a fee for said delivery of said information to said television interface receiving said information from said identified television service carrier.

5. The method for delivering information to a user according to claim 1, further comprising:
customizing said information for said user.

6. The method for delivering information to a user according to claim 1, wherein said information comprises consumer service information including at least one from among instructional information, operational information, setup information, configuration information, maintenance information, and service information.

7. The method for delivering information to a user according to claim 1, further comprising:
controlling delivery of said information via said identified television service carrier while said user is still in communication with a service representative at a call center provided by said consumer service center.

8. The method for delivering information to a user according to claim 1, further comprising:
communicating a scheduled time for delivery of said information to said television interface to a plurality of users via a communication medium; and
controlling delivery of said information to said television interface at said scheduled time for a community broadcast to said plurality of users.

9. The method for delivering information to a user according to claim 9, further comprising:
enabling at least one from among said plurality of users to select said scheduled time via said communication medium.

10. A system for delivering information to a user via a television service carrier, comprising:
a consumer service center communicatively connected to at least one network;
said consumer service center further comprising:
means for retrieving a television service carrier identification and account number for a user seeking information from said consumer service center,
means for contracting with said identified television service carrier for bandwidth for information delivery; and
means for delivering said information via said identified television service carrier in association with said account number, such that said user is able to receive said information at a television interface receiving said information over said contracted bandwidth from said identified television service carrier.

11. The system for delivering information to a user according to claim 10, further comprising:
means for receiving a call from said user at a call center provided by said consumer service center;
means for prompting said user to select to receive said information from said consumer service center via a television; and
means, responsive to said user selecting to receive said information from said consumer service center via said television, for retrieving said television service carrier identification for said identified television service carrier and said account number for said user.

12. The system for delivering information to a user according to claim 11, further comprising:
means for prompting said user by a service representative to select to receive said information from said consumer service center via said television; and
means for prompting said service representative to retrieve said television service carrier identification for said identified television service carrier and said account number from said user.

13. The system for delivering information to a user according to claim 10, further comprising:
means for charging said user a fee for said delivery of said information to said television interface receiving said information from said identified television service carrier.

14. The system for delivering information to a user according to claim 10, further comprising:
means for customizing said information for said user.

15. The system for delivering information to a user according to claim 10, wherein said information comprises consumer service information including at least one from among instructional information, operational information, setup information, configuration information, maintenance information, and service information.

16. The system for delivering information to a user according to claim 10, further comprising:
means for controlling delivery of said information via said identified television service carrier while said user is in communication with a service representative at a call center provided by said consumer service center.

17. The system for delivering information to a user according to claim 10, further comprising:
means for communicating a scheduled time for delivery of said information to said television interface to a plurality of users via a communication medium; and
means for controlling delivery of said information to said television interface at said scheduled time for a community broadcast to said plurality of users.

18. The system for delivering information to a user according to claim 17, further comprising:
means for enabling at least one from among said plurality of users to select said scheduled time via said communication medium.

19. A computer program product, residing on a computer readable medium, for delivering information to a user via a television service carrier, comprising:
means for retrieving a television service carrier identification and account number for a user seeking information from a consumer service center, wherein said consumer service center contracts with said identified television service carrier for bandwidth for information delivery; and
means for delivering said information via said identified television service carrier in association with said account number to a television interface.

20. The computer program product for delivering information to a user according to claim 19, further comprising:
means for receiving a call from said user at a call center provided by said consumer service center;
means for prompting said user to select to receive said information from said consumer service center via a television;
means, responsive to said user selecting to receive said information from said consumer service center via said television, for retrieving said television service carrier identification for said identified television service carrier and said account number for said user.

21. The computer program product for delivering information to a user according to claim 20, further comprising:
means for prompting said user by a service representative to select to receive said information from said consumer service center via said television; and
means for prompting said service representative to retrieve said television service carrier identification for said identified television service carrier and said account number from said user.

22. The computer program product for delivering information to a user according to claim 19, further comprising:
means for charging said user a fee for said delivery of said information to said television interface receiving said information from said identified television service carrier.

23. The computer program product for delivering information to a user according to claim 19, further comprising:
means for customizing said information for said user.

24. The computer program product for delivering information to a user according to claim 19, further comprising:
means for controlling delivery of said information via said identified television service carrier while said user is in communication with a service representative at a call center provided by said consumer service center.

25. The computer program product for delivering information to a user according to claim 19, further comprising:
means for communicating a scheduled time for delivery of said information to said television interface to a plurality of users via a communication medium; and
means for controlling delivery of said information to said television interface at said scheduled time for a community broadcast to said plurality of users.

26. The computer program product for delivering information to a user according to claim 25, further comprising:
means for enabling at least one from among said plurality of users to select said scheduled time via said communication medium.

27. A method for enabling consumer service centers to distribute consumer service information via a television service carrier, comprising
selecting a particular channel controlled by said television service carrier for use by a particular consumer service center, wherein said consumer service center receives a call from a user requesting consumer service information and prompts said user to provide a user account identifier to receive said consumer service information via said television service carrier to which said user subscribes;
responsive to receiving said user account identifier from said particular consumer service center, enabling an interface associated with said user account identifier for receiving a signal from said television service carrier to receive a signal from said particular channel; and
broadcasting consumer service information received from said particular consumer service center via said particular channel, such that said user receives said consumer service information via an existing subscription to said television service carrier.

28. A system for enabling consumer service centers to distribute consumer service information via a television service carrier, comprising
means for selecting a particular channel controlled by said television service carrier for use by a particular consumer service center, wherein said consumer service center receives a call from a user requesting consumer service information and prompts said user to provide a user account identifier to receive said consumer service information via said television service carrier to which said user subscribes;
means, responsive to receiving said user account identifier from said particular consumer
service center, for enabling an interface associated with said user account identifier for receiving a signal from said television service carrier to receive a signal from said particular channel; and
means for broadcasting consumer service information received from said particular consumer service center via said particular channel.

29. A computer program product, residing on a computer readable medium, for enabling consumer service centers to distribute consumer service information via a television service carrier, comprising
means for selecting a particular channel controlled by said television service carrier for use by a particular consumer service center, wherein said consumer service center receives a call from a user requesting consumer service information and prompts said user to provide a user account identifier to receive said consumer service information via said television service carrier to which said user subscribes;
means, responsive to receiving said user account identifier from said particular consumer service center, for enabling an interface associated with said user account identifier for receiving a signal from said television service carrier to receive a signal from said particular channel; and
means for broadcasting consumer service information received from said particular consumer service center via said particular channel.
